(19) United States
(12) Patent Application Publication
(10) Pub. No.: US 2025/0214374 A1
(43) Pub. Date: Jul. 3, 2025

(54) HIGHLY ADAPTIVE BICYCLE THROUGH AXLE

(71) Applicant: GLORY WHEEL ENTERPRISE CO., LTD., Taichung City (TW)

(72) Inventor: Chien-Hao LEE, Taichung City (TW)

(21) Appl. No.: 18/397,058

(22) Filed: Dec. 27, 2023

(51) Int. Cl. B60B 35/04

(52) U.S. Cl. CPC B60B 35/04; B60B 2900/112; B60B 2900/351; B60B 2900/531; B60B 2900/561

(57) ABSTRACT

A highly adaptive bicycle through axle having a spindle and a washer. The washer includes an inner surface and an outer surface that are not parallel to each other, thus accommodating different bicycle specifications.

### FIELD OF INVENTION

A bicycle through axle.

### BACKGROUND OF THE INVENTION

Known for their safety due to their ability to withstand greater torque and reduce the likelihood of wheel detachment, through axles have gradually replaced traditional quick releases and have become a rapidly evolving feature on modern bicycles. In particular, conical interface through axles are commonly used due to their larger locking surface area, which provides more stable support. Yet, the multitude of non-interchangeable specifications for existing conical interface through axles makes compatibility with different frame dropouts or seats difficult, resulting in elevated production costs and making it difficult for users to identify and select an appropriate through axle for their bicycles. Therefore, creating a highly adaptive bicycle through axle that is compatible with diverse specifications has become a keenly pursued goal in the related field.

### SUMMARY OF THE INVENTION

To remedy the problem of increased production costs and difficulty for users in identifying and selecting the appropriate bicycle axle due to the multitude of axle specifications, the present invention provides a highly adaptive bicycle axle.

The present invention provides a highly adaptive bicycle through axle, comprising: a spindle, including a tail end and a head end defined at two ends, where the tail end has a threaded surface formed on an outer surface; the head end includes a large head, which is a cylinder toward the head end, defining a cylindrical surface; the large head is inwardly recessed toward the tail end to form a conical interface that forms a first angle with an axial direction of the spindle; and a washer, including an inner surface and an outer surface, where the inner surface corresponds to the conical interface and the outer surface forms a second angle with the axial direction, the first and second angles being different.

Wherein, the angular range of the second angle is between 40° and 140°.

Further, the washer is ring-shaped, with a circumferential surface having an opening.

Further, the inner surface of the washer has a recess, in which a lubricating component is placed.

Preferably, the inner surface of the washer has a recess, in which lubricating grease is stored.

Further, the outer surface of the spindle has one or more protrusions so that the outer surface of the washer contacts the protrusions and rotates only around the spindle.

Moreover, the washer completely covers the cylindrical surface and the conical interface of the large head.

Through the above technical means, the present invention achieves adaptability to many bicycle specifications by simply changing the characteristics of the washer, thereby reducing production costs and making it more convenient for users.

### BRIEF DESCRIPTION OF THE DRAWINGS

FIG. 1 is a perspective view of a first embodiment of the present invention;

FIG. 2 is a partially enlarged sectional view of the first embodiment of the present invention;

FIG. 3 is a partially enlarged perspective view of a second embodiment of the present invention;

FIG. 4 is a partially enlarged sectional view of a third embodiment of the present invention;

FIG. 5 is a partially enlarged sectional view of a fourth embodiment of the present invention;

FIG. 6 is a partially enlarged sectional view of the first embodiment of the present invention;

FIG. 7 is a partially enlarged sectional view of a fifth embodiment of the present invention; and

FIG. 8 is a partially enlarged sectional view of a sixth embodiment of the present invention.

### DETAILED DESCRIPTION OF THE PREFERRED EMBODIMENTS

In order to more clearly illustrate the technical solutions of the embodiments of the present invention, the accompanying drawings used in the description of each embodiment are briefly introduced herein. It will be appreciated that the accompanying drawings described below are merely some examples or embodiments of the present invention, and that the present invention may be applied to other similar situations by those skilled in the art without the need for creative effort. Unless otherwise clearly indicated or explained by the context, the same reference numbers in the drawings represent the same structures or operations.

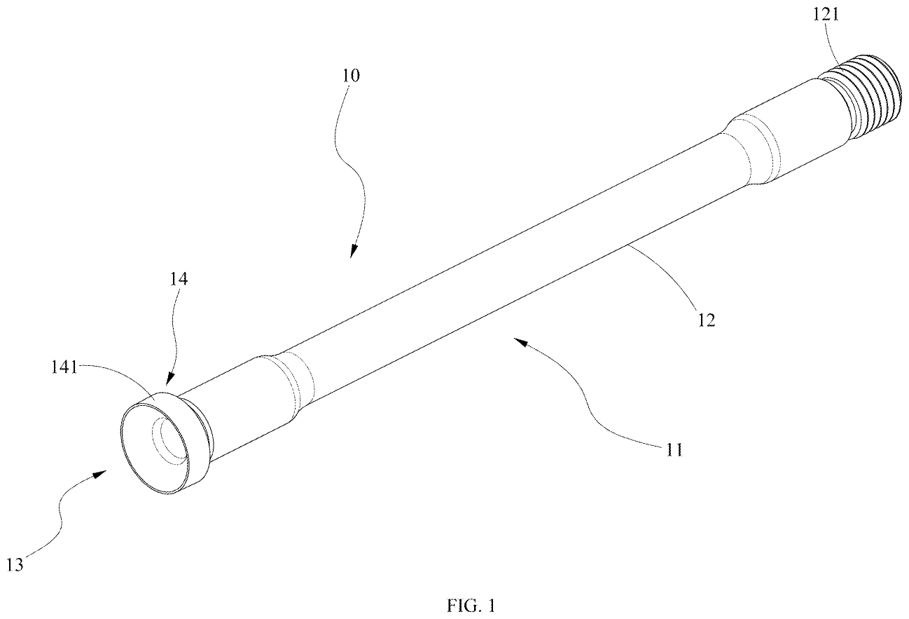

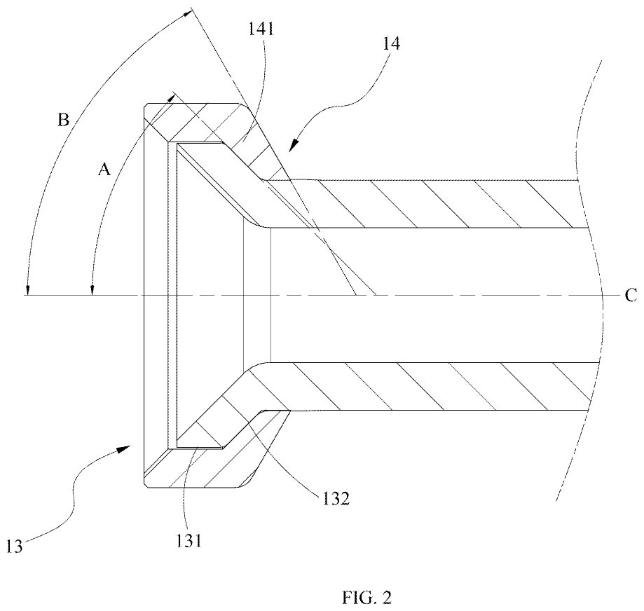

Referring to FIGS. 1 and 2, a first embodiment of a highly adaptive bicycle through axle 10 provided by the present invention is shown. The highly adaptive bicycle through axle 10 includes a spindle 11 having a tail end and a head end defined at two ends, wherein the tail end has a threaded surface 121 formed on an outer surface 12; the head end includes a large head 13, which is a cylinder toward the head end and defines a cylindrical surface 131; the large head 13 is inwardly recessed toward the tail end to form a conical interface 132 that forms a first angle A with an axial direction C of the spindle 11; the highly adaptive bicycle through axle 10 also includes a washer 14, and the washer 14 comprises an inner surface and an outer surface, wherein the inner surface corresponds to the conical interface 132 and the outer surface forms a second angle B with the axial direction C, and the first angle A and the second angle B are different, with the second angle B corresponding to a slanted surface of a bicycle fork used to secure the through axle; wherein the angular range of the second angle B is between 40° and 140°.

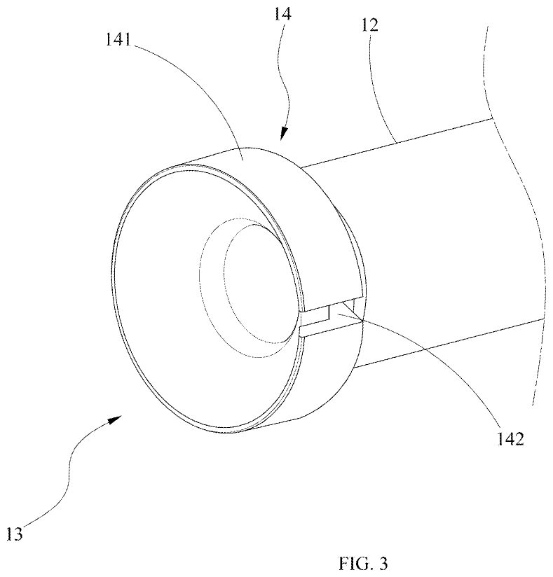

Referring to FIG. 3, a second embodiment of the highly adaptive bicycle through axle 10 provided by the present invention is shown. An opening 142 is provided on a circumferential surface 141 of the washer 14. The opening 142 can expand when a force is applied, making it easier to install or remove the washer 14 onto or from the conical interface 132 of the spindle 11.

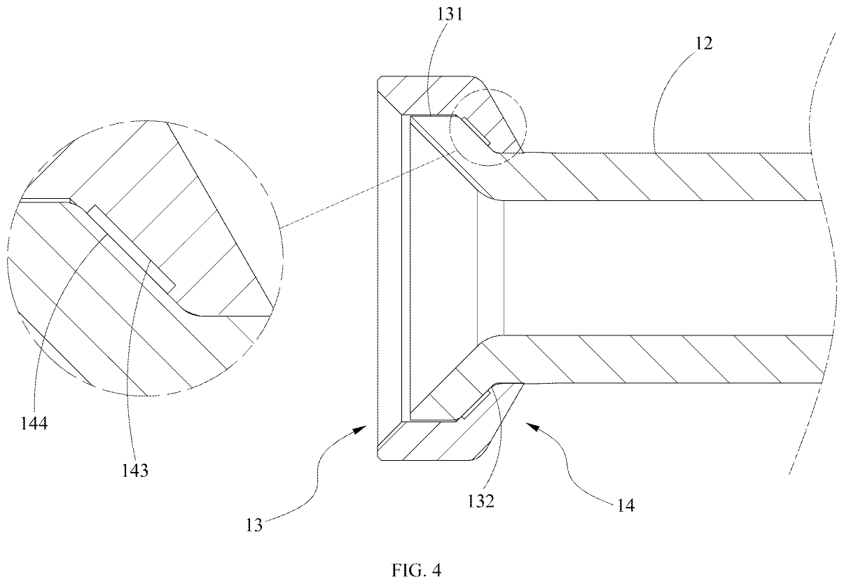

Referring to FIG. 4, a third embodiment of the highly adaptive bicycle through axle 10 provided by the present invention is shown. In this embodiment, the inner surface of the washer 14 includes a recess 143, in which a lubricating component 144 is placed. The lubricating component 144 can be any material that reduces the friction between the washer 14 and the conical interface 132. Preferably, the lubricating component 144 is a polytetrafluoroethylene tape or a lubricating grease.

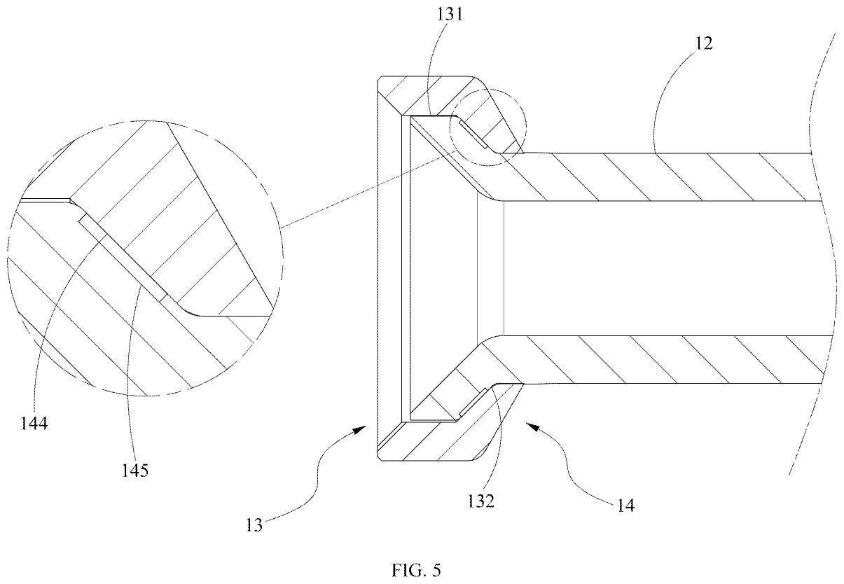

Referring to FIG. 5, a fourth embodiment of the highly adaptive bicycle through axle 10 provided by the present invention is shown. In this embodiment, the conical interface 132 of the large head 13 includes a recess 145, in which the lubricating component 144 is placed. The lubricating component 144 can be any material that reduces the friction between the conical interface 132 and the washer 14. Preferably, the lubricating component 144 is a polytetrafluoroethylene tape or a lubricating grease.

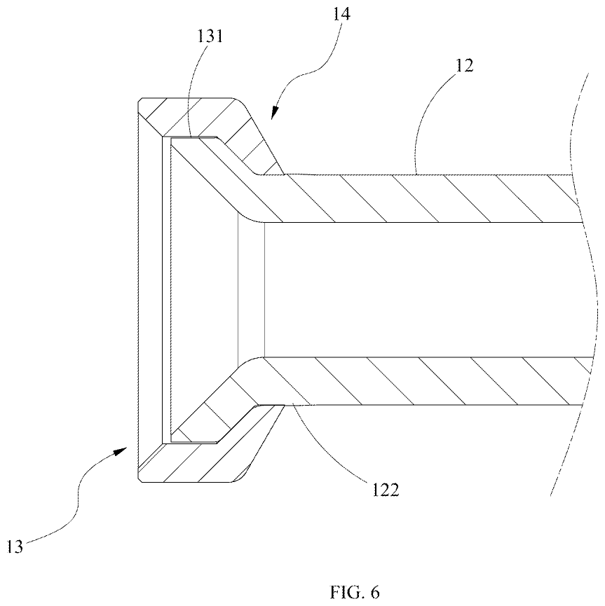

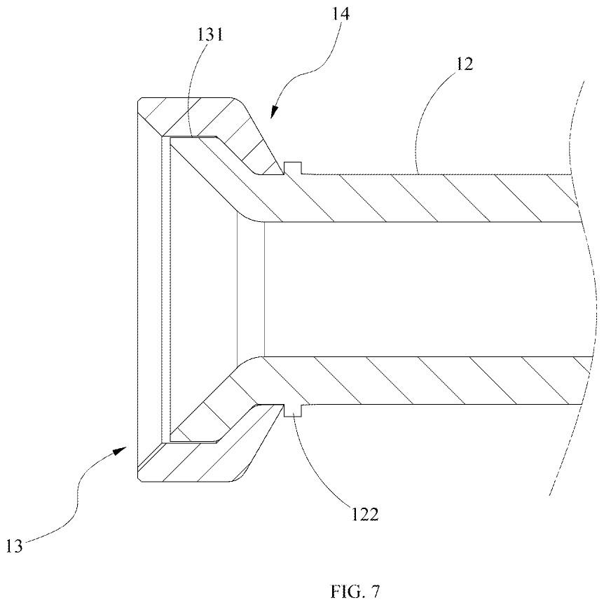

Further, reference is made to FIGS. 6 and 7, which are embodiments of the highly adaptive bicycle through axle 10 provided by the present invention, namely the first embodiment and a fifth embodiment, respectively. Referring to FIG. 5, in the first embodiment, the outer surface 12 of the spindle 11 in the vicinity of the large head 13 has four protrusions 122, the outer surface of the washer 14 can rest against these protrusions 122 so that the inner surface of the washer 14 is fixedly attached to the conical interface 132 of the large head 13 and can rotate only along the axial direction C and cannot slide arbitrarily on the outer surface 12 of the spindle 11. Referring to FIG. 6, in the further embodiment, the outer surface 12 of the spindle 11 near the large head 13 has two larger protrusions 122 so that the inner surface of the washer 14 to be fixedly attached to the conical interface 132 of the large head 13 and not slide. The protrusions 122 facilitate the user in installing the washer 14 and prevent it from slipping when installing the highly adaptive bicycle through axle 10 on a bicycle.

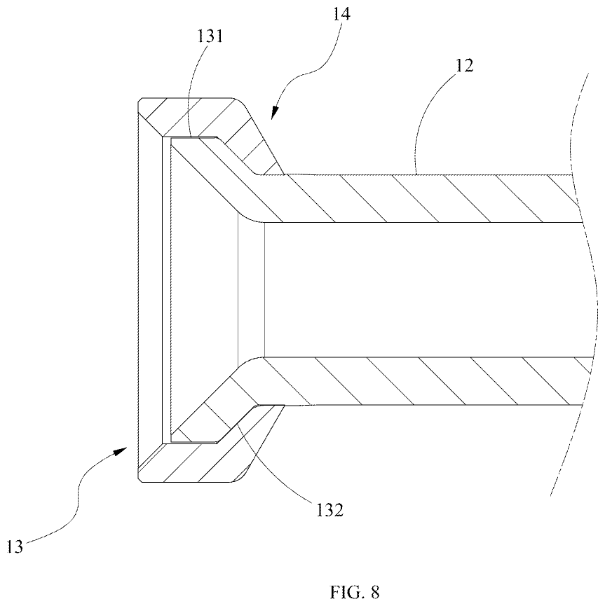

Reference is further made to FIG. 8, which shows a sixth embodiment of the highly adaptive bicycle through axle 10 provided by the present invention. Because the inner surface of the washer 14 completely covers the conical interface 132 and the cylindrical surface 131 of the large head 13, this embodiment of the washer 14 has a larger contact surface with the large head 13, thereby reducing the likelihood that the washer 14 will inadvertently become detached.

From the aforementioned descriptions, it can be known that the present invention achieves the following effects:
1. In manufacturing the through axle spindle, it is no longer necessary to make additional molds and design different specifications for different standards. Only one type of through axle needs to be produced, and it can be adapted to different bicycle application requirements by pairing it with a customizable washer whose outer surface corresponds to the conical interface of different bicycle fork through axle fixings.
2. Users no longer need to worry about using through axles with mismatched specifications, and since the through axle spindle does not need to be customized for different bicycle standards, this significantly reduces production costs, allowing users to choose more economical through axles.

It should be noted that, according to the interpretation and explanation of the above description, those skilled in the art may still make changes and modifications to the above-described embodiments. Therefore, this disclosure is not limited to the specific embodiments disclosed and described above, and some equivalent modifications and changes to this disclosure should also be within the scope of the claims of this disclosure. Moreover, although certain specific terms are used in this specification, these terms are used for the convenience of description only and are not intended to limit the invention.

What is claimed is:

1. A highly adaptive bicycle through axle, comprising:
a spindle, with a tail end and a head end defined at two ends; the head end comprises a large head, and the large head is a cylinder toward the head end and defines a cylindrical surface; the large head is inwardly recessed toward the tail end to form a conical interface that forms a first angle with an axial direction of the spindle; and
a washer, comprising an inner surface and an outer surface, where the inner surface corresponds to the conical interface, and the outer surface forms a second angle with the axial direction, and the first and second angles are different.

2. The highly adaptive bicycle through axle according to claim 1, wherein the angular range of the second angle is between 40° and 140°.

3. The highly adaptive bicycle through axle according to claim 2, wherein the washer is ring-shaped, with a circumferential surface having an opening.

4. The highly adaptive bicycle through axle according to claim 2, wherein the inner surface of the washer has a recess, and a lubricating component is placed in the recess.

5. The highly adaptive bicycle through axle according to claim 3, wherein the inner surface of the washer has a recess, and a lubricating grease is stored in the recess.

6. The highly adaptive bicycle through axle according to claim 2, wherein the conical interface of the large head has a recess, and a lubricating component is placed in the recess.

7. The highly adaptive bicycle through axle according to claim 3, wherein the conical interface of the large head has a recess, and a lubricating grease is stored in the recess.

8. The highly adaptive bicycle through axle according to claim 3, wherein the outer surface of the spindle has at least one protrusion so that the outer surface of the washer contacts the protrusion and rotates only around the spindle.

9. The highly adaptive bicycle through axle according to claim 3, wherein the washer completely covers the cylindrical surface and the conical interface of the large head.
